(19) United States
(12) Patent Application Publication
(10) Pub. No.: US 2023/0379679 A1
(43) Pub. Date: Nov. 23, 2023

(54) SYSTEMS AND METHODS FOR HANDLING MISSION CRITICAL SERVICE IN WIRELESS COMMUNICATION SYSTEM

(71) Applicant: Samsung Electronics Co., Ltd., Gyeonggi-do (KR)

(72) Inventors: Kiran Gurudev KAPALE, Bangalore (IN); Arunprasath RAMAMOORTHY, Bangalore (IN); Basavaraj Jayawant PATTAN, Bangalore (IN)

(21) Appl. No.: 18/029,997

(22) PCT Filed: Oct. 5, 2021
(86) PCT No.: PCT/KR2021/013600

§ 371 Date: Apr. 3, 2023

(30) Foreign Application Priority Data
Oct. 5, 2020 (IN) 202041043258
Jun. 21, 2021 (IN) 202041043258

(51) Int. Cl. H04W 4/90; H04W 4/12

(52) U.S. Cl. CPC H04W 4/90; H04W 4/12

(57) ABSTRACT

Embodiments herein disclose a method for handling a MC service in a wireless communication system (300). The method includes receiving, by a MCData server (200), a MCData deferred messages list request to get a MCData deferred messages list from a MCData client (100a). Further, the method includes sending, by the MCData server (200), a MCData deferred messages list response to the MCData client (100a) based on the received MCData deferred messages list request. The MCData deferred messages list response includes a MCData group ID, a deferred signalling payload and at least one parameter.

### TECHNICAL FIELD

Embodiments disclosed herein relate to mission critical services (MCS) and more particularly to methods and systems for handling deferred messages in a wireless communication system during the MCS.

### BACKGROUND ART

To meet the ever-increasing demand for wireless data traffic since the commercialization of 4th generation (4G) communication systems, efforts have been made to develop improved 5th generation (5G) or pre-5G communication systems. As such, 5G or pre-5G communication systems are also called “beyond 4G network system” or “post Long-Term Evolution (LTE) system”. To achieve high data rates, 5G communication systems are being considered for implementation in the extremely high frequency (millimeter (mm) Wave) band (e.g., 60 gigahertz (GHz) band). To decrease path loss of radio waves and increase the transmission distance in the mmWave band, various technologies including beamforming, massive multiple-input multiple-output (massive MIMO), full dimensional MIMO (FD-MIMO), array antennas, analog beamforming, and large-scale antennas are considered for 5G communication systems. In addition, to improve system networks in 5G communication systems, technology development is under way regarding evolved small cells, advanced small cells, cloud radio access networks (cloud radio access networks (RANs)), ultra-dense networks, device-to-device (D2D) communication, wireless backhaul, moving networks, cooperative communication, coordinated multi-points (CoMP), interference cancellation, and the like. Additionally, advanced coding and modulation (ACM) schemes, such as hybrid frequency shift keying and quadrature amplitude modulation (FQAM) and sliding window superposition coding (SWSC), and advanced access technologies, such as filter bank multi carrier (FBMC), non-orthogonal multiple access (NOMA), and sparse code multiple access (SCMA) are also under development for 5G systems.

Meanwhile, the Internet is evolving from a human centered network where humans create and consume information into the Internet of Things (IoT) where distributed elements, such as things exchange and process information. There has also emerged the Internet of Everything (IoE) technology that combines IoT technology with big data processing technology through connection with cloud servers. To realize IoT, technology elements related to sensing, wired/wireless communication and network infrastructure, service interfacing, and security are needed, and technologies interconnecting things, such as sensor networks, machine-to-machine (M2M) or machine type communication (MTC) are under research in recent years. In IoT environments, it is possible to provide intelligent Internet technology services, which collect and analyze data created by interconnected things to add new values to human life. Through convergence and combination between existing information technologies and various industries, IoT technology may be applied to various areas, such as smart homes, smart buildings, smart cities, smart or connected cars, smart grids, health-care, smart consumer electronics, and advanced medical services.

Accordingly, various attempts are being made to apply 5G communication systems to IoT networks. For example, sensor networks and machine-to-machine (M2M) or machine type communication (MTC) are being realized by use of 5G communication technologies including beamforming, MIMO, and array antennas. Application of cloud RANs as a big data processing technique described above may be an instance of convergence of 5G technology and IoT technology.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The principal object of the embodiments herein is to disclose methods and systems for handling a MCS in a wireless communication system.

Another object of the embodiments herein is to disclose methods and systems for handling deferred messages and enhancing procedures, which are needed because of changes introduced in MCData functional architecture since Release 16 onwards.

Another object of the embodiments herein is to disclose methods and systems for enabling a MCData server to know whether a MCData user has downloaded a file or not if a sending user is not requesting for a download completed report and enable the MCData server maintaining deferred messages list to update the deferred messages list.

Another object of the embodiments herein is to disclose additional dependent information to be provided to a MCData client, when the MCData client requests for the deferred messages list from the MCData server.

### Solution to Problem

Accordingly, embodiments herein provide a method for handling a MC service in a wireless communication system. The method includes receiving, by a Mission Critical Data (MCData) server, a MCData deferred messages list request to get a MCData deferred messages list from a MCData client. Further, the method includes sending, by the MCData server, a MCData deferred messages list response to the MCData client based on the received MCData deferred messages list request. The MCData deferred messages list response includes a MCData group identifier (ID), a deferred signalling payload and at least one parameter.

In an embodiment, sending, by the MCData server, the MCData deferred messages list response includes performing at least one of setting a number of payloads information element (IE) to a number of File Distribution (FD) in the MCData deferred messages list response using a communication which is deferred as per a stored deferred group communication, copying a deferred FD signalling payload IE value from a stored list to a deferred FD signalling payload IE value of an outgoing message being generated for each deferred group communication, and copying a MCData group ID from a stored list to a MCData group ID IE values of an outgoing message.

In an embodiment, the MCData server receives the MCData deferred messages list request to get the MCData deferred messages list from the MCData client when the MCData client wants to obtain a list of deferred data group communications.

In an embodiment, the method further includes receiving, by the MCData server, a disposition notification, where the disposition notification is targeted to a FD request associated with another MCData client if the another MCData client is requested for the disposition notification.

In an embodiment, the deferred signalling payload comprises a signalling content related to a FD data payload and coded as per 3GPP 24.282 standard.

In an embodiment, an IE of the deferred FD signaling payload is a type 6 information element.

In an embodiment, the at least one parameter associated with the MCData deferred messages list request that is deferred comprises an originator of a MCData communication request, a conversation ID, a message ID, an in-reply-to message ID, an application ID, a FD disposition request type, a payload, a metadata, an extended application ID and a date and time.

Accordingly, embodiments herein provide a method for handling a MC service in a wireless communication system. The method includes receiving, by a MCData server, a FD disposition notification message from a first MCData client. Further, the method includes determining, by the MCData server, whether a disposition information has been indicated in the FD disposition notification message. The disposition information has been requested by a second MCData client, Further, the method includes performing, by the MCData server, one of sharing the FD disposition notification message with the second MCData client, clearing a deferred message in a deferred message list in the MCData server, and updating the deferred message list in the MCData server upon determining that the disposition information has been indicated in the FD disposition notification message, and clearing a deferred message in a deferred message list in the MCData server and updating the deferred message list in the MCData server, upon determining that the disposition information not indicated in the FD disposition notification message.

In an embodiment, the disposition notification message allows the MCData server to identify whether the first MCData client has downloaded a content or not.

In an embodiment, the method further includes receiving, by the MCData server, a FD disposition notification response message from the second MCData client. Further, the method includes forwarding, by the MCData server, the FD disposition notification response message to the first MCData client.

### Advantageous Effects of Invention

Accordingly, embodiments herein provide a method for handling a MC service in a wireless communication system. The method includes obtaining, by a MCData client, a list comprising at least one deferred data group communication message. Further, the method includes sending, by the MCData client, a MCData deferred messages list request to get a MCData deferred messages list to a MCData server upon obtaining the list comprising of at least one deferred data group communication message. Further, the method includes receiving, by the MCData client, a MCData deferred messages list response from the MCData server based on the MCData deferred messages list request, wherein the MCData deferred messages list response comprises a MCData group ID, a deferred signalling payload and at least one parameter.

In an embodiment, the method further includes sending, by the MCData client, a disposition notification to the MCData server, wherein the disposition notification is targeted to another MCData client of a FD request if the another MCData client is requested for the disposition notification.

Accordingly, embodiments herein provide a MCData server for handling a MC service in a wireless communication system. The MCData server includes a MCData handler coupled with a processor and a memory. The MCData handler is configured to receive a MCData deferred messages list request to get a MCData deferred messages list from a MCData client. Further, the MCData handler is configured to send a MCData deferred messages list response to the MCData client based on the received MCData deferred messages list request. The MCData deferred messages list response includes a MCData group ID, a deferred signalling payload and at least one parameter.

Accordingly, embodiments herein provide a MCData server for handling a MC service in a wireless communication system. The MCData server includes a MCData handler coupled with a processor and a memory. The MCData handler is configured to receive a FD disposition notification message from a first MCData client. Further, the MCData handler is configured to determine whether a disposition information, has been indicated in the FD disposition notification message. The disposition information has been requested by a second MCData client. Further, the MCData handler is configured to perform one of share the FD disposition notification message with the second MCData client, clear a deferred message in a deferred message list in the MCData server, and update the deferred message list in the MCData server upon determining that the disposition information has been indicated in the FD disposition notification message, and clear a deferred message in a deferred message list in the MCData server and update a deferred message list in the MCData server upon determining that the disposition information not indicated in the FD disposition notification message.

Accordingly, embodiments herein provide a MCData client for handling a MC service in a wireless communication system. The MCData client includes a MCData handler coupled with a processor and a memory. The MCData handler is configured to obtain a list including at least one deferred data group communication message. Further, the MCData handler is configured to send MCData deferred messages list request to get a MCData deferred messages list to a MCData server upon obtaining the list of deferred data group communication message. Further, the MCData handler is configured to receive a MCData deferred messages list response from the MCData server based on the received MCData deferred messages list request. The MCData deferred messages list response includes a MCData group ID, a deferred signalling payload and at least one parameter.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 is a sequence flow diagram illustrating step by step operations for handling MCS in a wireless communication system;

FIG. 2 is a sequence flow diagram illustrating step by step operations for handling MCS in the wireless communication system while accessing list of deferred data group communications;

FIG. 3 is an overview of a wireless communication system for handling a MCS, according to embodiments as disclosed herein;

FIG. 4 shows various hardware components of a MCPPT client, according to embodiments as disclosed herein;

FIG. 5 shows various hardware components of a MCPPT server, according to embodiments as disclosed herein;

FIG. 6 and FIG. 7 are flow charts illustrating a method, implemented by the MCPTT server, for handling the MCS in the wireless communication network, according to embodiments as disclosed herein;

FIG. 8 is a flow chart illustrating a method, implemented by the MCPTT client, for handling the MCS in the wireless communication network, according to embodiments as disclosed herein;

FIG. 9 is a sequence flow diagram illustrating step by step operations for handling the MCS in the wireless communication network, while accessing list of deferred data group communications, according to embodiments as disclosed herein;

FIG. 10 is a sequence flow diagram illustrating step by step operations for handling the MCS in the wireless communication network, while handling a disposition notification, according to embodiments as disclosed herein; and

FIG. 11 depicts a deferred signalling payload information element, according to embodiments as disclosed herein.

FIG. 12 depicts deferred FD signalling payload contents respectively, according to embodiments as disclosed herein.

### MODE FOR THE INVENTION

The 3^{rd} Generation Partnership Project technical specification (3GPP TS) 23.282 has defined a Mission Critical Data (MCData) content server and a MCData message store as new functional entities from Release 16 onwards. The MCData content server provides a repository area in a MCData trust domain allowing authorized MCData users to temporarily store files that are intended to be shared with other MCData users. The MCData content server provides a common pool of storage area (i.e., size) to all authorized MCData users to use, with no personal space being allocated. An authorized MCData user can use supported operations on a defined reference point to upload shared files and download the files that are shared to him/her. The MCData content server acts as a temporary storage for the files to be distributed. A MCData client of the MCData user distributing the file will upload the file to the MCData content server and distribute a file URL to a recipient MCData user or a MCData group. The recipient MCData user can download the file from the MCData content server or he/she can defer the file download.

Further, the MCData message store is used by the MCData users to store their MCData communications permanently. Further, the MCData message store shall provide a secured storage area for each authorized MCData user having a user account. The storage area is identified by MCData user's MCData ID. The MCData message store shall allow the MCData user to access only the storage area that he/she is authorized to access. A user (i.e. a dispatcher) other than the user account holder shall be able to access the account holder's storage area if authorized.

Deferred messages functionality enables the recipients of the file content shared over http to defer the download of the file content and can be downloaded at later point of time. Currently these deferred messages are stored by the MCData server which periodically announces a list of available data waiting to download in the deferred messages list. When a time to live (TTL) value of the file is expired then the MCData server notifies the MCData user that the Data expired and not available to download anymore. Also, the MCData user can get the list of deferred messages list from the MCData server and act on it. Once the file is downloaded the MCData server removes the details of that file from the deferred messages list.

Below are limitations in the existing solutions:
a. Currently there is no way for the MCData server to know whether the MCData user has downloaded the file or not if a sending user is not requesting for the download completed report. In this case, the MCData server maintaining the deferred messages list will not be able to update it.
b. Currently the existing procedure responded with the file URL alone when the MCData user requests for the deferred list. File URL alone would not be sufficient for the MCData client to handle the deferred messages.

Based on latest development in the 3GPP TS 23.282 V17.1.0, the Media storage function is made as a stand-alone entity which can reside outside of the MCData server and as part of the MCData content server. With this architectural changes the way how the deferred messages are handled cannot be fulfilled completely.

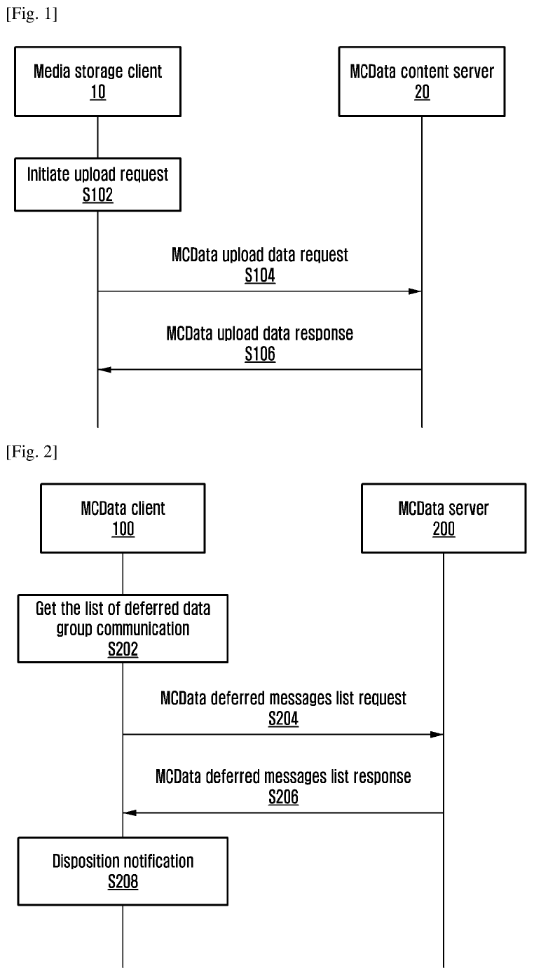

FIG. 1 is a sequence flow diagram illustrating step by step operations for handling MCS in a wireless communication system. At S102, the media storage client (10) initiates an upload request. At S104, the media storage client (10) sends a MCData upload data request to a MCData content server (20). Based on the MCData upload data request, at S106, the media storage client (10) receives the MCData upload data response from the MCData content server (20).

FIG. 2 is a sequence flow diagram illustrating step by step operations for handling MCS in the wireless communication system while accessing a list of deferred data group communications. At S202, the MCData client (100) gets the list of deferred data group communication. At S204, the MCData client (100) sends the MCData deferred messages list request to the MCData server (200). Based on the MCData deferred messages list request, at S206, the MCData client (100) receives the MCData deferred messages list response from the MCData server (200). At S208, MCData client (100) sends the disposition notification.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The terms “MCData UE” and “MCData client” are used interchangeably in the patent disclosure.

The embodiments herein achieve a method for handling a MC service in a wireless communication system. The method includes receiving, by a MCData server, a MCData deferred messages list request to get a MCData deferred messages list from a MCData client. Further, the method includes sending, by the MCData server, a MCData deferred messages list response to the MCData client based on the received MCData deferred messages list request. The MCData deferred messages list response includes a MCData group ID, a deferred signalling payload and at least one parameter.

The proposed method can be used to enable the MCData server to know whether the MCData user has downloaded the file or not if a sending user is not requesting for the download completed report and enable the MCData server maintaining the deferred messages list to update the deferred messages list. Further, the method can be used to provide dependent information to be provided to a MCData client, when the MCData client requests for the deferred messages list from the MCData server. This results in enhancing the resource utilization and improving the user experience.

The various embodiments of the proposed method are implanted in the 3GPP TS 24.282.

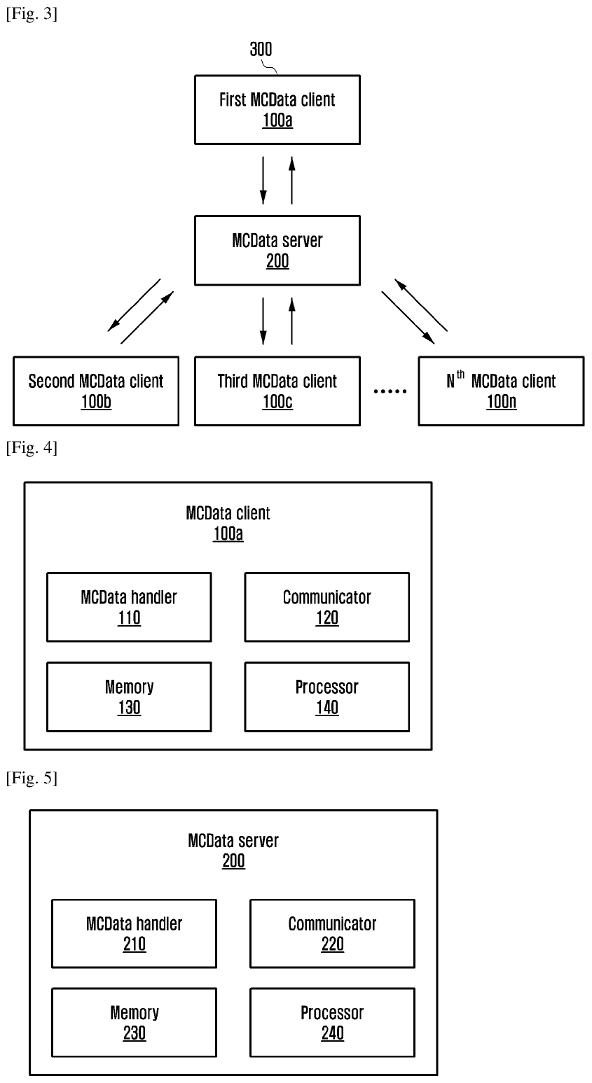

Referring now to the drawings, and more particularly to FIGS. 3 through 11b, where similar reference characters denote corresponding features consistently throughout the figures, there are shown at least one embodiment.

FIG. 3 is an overview of a wireless communication system (300) for handling the MCS, according to embodiments as disclosed herein. The wireless communication system (300) can be a MCData network. In an embodiment, the wireless communication system (300) includes one or more MCData client (100a-100n) and a MCData server (200). The one or more MCData client (100a-100n) can be, for example, but not limited to a cellular phone, a smart phone, a smart watch, a Personal Digital Assistant (PDA), a tablet computer, a laptop computer, a virtual reality device, an immersive system, an Internet of Things (IoT), a smart sensor, a drone, a vehicle or the like. The one or more MCData client (100a-100n) is communicated with the MCData server (200) and a network entity (not shown). The network entity may also include or be referred to by those skilled in the art as a base station, a base transceiver station, a radio base station, an access point, a radio transceiver, an eNB, a gNodeB (GNB), a fifth generation (5G) eNB, or the like. The one or more MCData client (100a-100n) communicates with the wireless communications system (300) through the network entity. The MCPTT network defines a concept of shareable MCData client (100a-100n). In an embodiment, the shareable MCData client (100a-100n) can be considered as a pool of MCData clients, where each MCData client being interchangeable with any other MCData responders/users (Public Safety (PS) agent), and MCPTT users/responders/PS agent randomly choosing one or more MCData client from the pool.

In an embodiment, the MCData server (200) is configured to receive a MCData deferred messages list request to get a MCData deferred messages list from a first MCData client (100a). In an embodiment, the MCData server (200) receives the get MCData deferred messages list request from the MCData client (100a) when the MCData client (100a) obtains a list of deferred data group communication. Based on the received MCData deferred messages list request, the MCData server (200) is configured to send a MCData deferred messages list response to the MCData client (100a). The MCData deferred messages list response includes a MCData group ID, a deferred signalling payload and one or more parameter. The deferred signalling payload includes a signalling content related to a FD data payload and coded as per 3GPP 24.282 standard. An IE of the deferred FD signaling payload is a type 6 information element. The one or more parameter associated with the MCData deferred messages list request that is deferred comprises an originator of a MCData communication request, a conversation ID, a message ID, an in-reply-to message ID, an application ID, a FD disposition request type, a payload, a metadata, an extended application ID and a date and time.

In an embodiment, send the MCData deferred messages list response includes set a number of payloads information element (IE) to a number of FD using a communication which is deferred as per a stored deferred group communication. In another embodiment, send the MCData deferred messages list response includes copy a deferred FD signalling payload IE value from a stored list to a deferred FD signalling payload IE value of an outgoing message being generated for each deferred group communication. In another embodiment, send the MCData deferred messages list response includes copy a MCData group ID from a stored list to a MCData group ID IE values of an outgoing message.

Further, the MCData server (200) is configured to receive a disposition notification. The disposition notification is targeted to a FD request associated with another MCData client (100b) if the another MCData client (100b) is requested for the disposition notification.

In another embodiment, the MCData server (200) is configured to receive a FD disposition notification message from a first MCData client (100a). The disposition notification message allows the MCData server (200) to identify whether the first MCData client (100a) has downloaded a content or not. After receiving the FD disposition notification message, the MCData server (200) is configured to determine whether a disposition information has been indicated in the FD disposition notification message. The disposition information has been requested by a second MCData client (100b). If the disposition information has been indicated in the FD disposition notification message then, the MCData server (200) is configured to share the FD disposition notification message with the second MCData client (100b), clear a deferred message in a deferred message list, and update the deferred message list. If the disposition information not indicated in the FD disposition notification message then, the MCData server (200) is configured to clear a deferred message in the deferred message list and update the deferred message list in the MCData server (200).

Further, the MCData server (200) is configured to receive the FD disposition notification response message from the second MCData client (100b) and forward the FD disposition notification response message to the first MCData client (100a).

The proposed method can be used to extend a deferred data response to include other dependent information. The proposed method can be used to mandate the MCData server (200) receiving the MCData download completed report from the first MCData client (100a) even if it is not requested by the MCData user sending the file. Further, the proposed method can be used to enable a receiving MCData client (e.g., MCData client (100a)) to mandatorily indicate the MCData server (200) with file download completed indication even though the sending user has not requested for it. The proposed method can be used to deposit the deferred messages to MCData message store and handle the deferred messages.

Deferred Messages handling: Deferred messages functionality enables the recipients of the file content shared over http to defer the download of the file content and can be downloaded at later point of time. Currently these deferred messages are stored by the MCData server (200) which periodically announces the list of available data waiting to download in the deferred messages list. When the time to live (TTL) value of the file is expired then the MCData server (200) notifies the MCData user that the data expired and not available to download anymore. Also, the MCData user can get the list of deferred messages list from the MCData server (200) and act on it. Once the file is downloaded, the MCData server (200) removes the details of that file from the deferred messages list.

MCData message store based solution: With the MCData message store based solution, the MCData server (200) deposits an object containing the details of the deferred messages into the MCData user account of MCData message store. The details of the deferred messages can be synched to the MCData client (100a) with a synchronization mechanism between a MCData message store function and MCData message store client. The synchronization mechanism is already defined in the 3GPP TS 24.282. The MCData message store function tracks the TTL of the file shared and update the deferred message object accordingly when the TTL is expired and the file is not downloaded by the client (100a). The MCData server (200) on receiving the download completed report from the MCData client (100a) should update the deferred message list accordingly.

Embodiments herein store the following information as part of the deferred message list: URL of the file, sender of the file, group ID if its group distribution, Timestamp of the distribution, TTL, Size of the file, Conversation Identifier, Transaction Identifier, Reply identifier, and so on. The information can be stored in an extensible markup language (XML), JavaScript Object Notation (JSON) or any other format. Most of this information are present already in the received FD signaling payload.

Below is the process of the MCData server (200) depositing a deferred message object into a MCData message store account of the MCData user when the file download is deferred by the MCData user. For the sake of brevity, the requests and responses involving only the recipient is shown.

In step 1, the MCData server (200) sends a FD request to a recipient MCData Client (100a). In step 2, the receiving MCData client (100b) notifies the user about the incoming MCData FD request (including file metadata, if present) which may be either accepted or rejected or ignored. In step 3, the MCData client (100a) responds to the FD request. In step 4, the user decides to defer the download and hence the MCData client (100a) sends a FD disposition notification (DEFERRED) to the MCData server (200). In step 5, the MCData server (200), on receiving the FD disposition (DEFERRED), creates a deferred message object containing all the details of the FD request and deposits the object into the MCData users account on MCData message store in a specific folder which can be distinguished that the objects residing inside that folder are of deferred messages. In step 6, the MCData message store deposits the object into the MCData user's storage area and communicates the result back to the MCData server (200) in the MCData deposit an object response. The object identifier for the stored is returned in the MCData deposit as an object response. In step 7, The MCData message store sends the MCData synchronization notification to the message store client residing as part of MCData client. Based on the notification, the MCData client (100a) retrieves the object from the MCData message store as and when required and notifies the user about the details of deferred messages. The MCData client (100a) may set filters such a way that it synchronizes only this folder.

Extensions to the existing MCData server based deferred messages handling: Currently in the existing mechanism, the MCData server (200) manages the deferred messages. But the existing mechanism has the following limitations:
1. Since the recipients download the file from the MCData server (200), there is no way for the MCData server (200) to know whether the recipient has downloaded or not if the MCData user sending the file is not requesting for the MCData download completed report. So, if the file request is deferred and downloaded later, then the MCData server (200) has no mechanism of purging the deferred list.
2. The existing payload structure does not carry any details about the details of the file distribution request. When the MCData client (100a) gets the list of deferred messages it may not have all the required details.

Embodiments herein extend the existing mechanism to overcome the above limitations. In order to overcome the limitation of tracking of whether the MCData user has downloaded the deferred file or not, embodiments herein propose to use any of the below procedures:
1. The MCData client (100a) mandatorily generating the FD notification indicating file download completed and indicating that the notification is for the MCData server (200) consumption by not including the target user if the originator has not requested for it (or), and
2. The MCData server (200) mandatorily requesting the MCData client (100a) to send the FD disposition notification for download completed by setting the FD disposition request type with FILE DOWNLOAD COMPLETED UPDATE and with some indication for only server consumption.

The extension to payload structure is required for both of the procedures as described above.

Extension to the payload structure: Currently in the existing specification, the payload structure of the deferred messages is not well defined and because of this, it may lead to interoperability issues. Embodiments herein propose the details of what information to be stored as part of the deferred message list so that the MCData client (100a) when retrieves the deferred messages list or when the MCData server (200) periodically notifies the list of deferred messages list, it will have all the required information.

Embodiments herein propose the below changes to the structure of the payload carried in the deferred data response message specified in TS 24.282.

Embodiments herein capture the changes required for handling the deferred data response message to include the additional dependent data. Changes mentioned here are applicable to the specification 24.282 of release 17. The same changes can be applied for earlier versions also. Subclauses mentioned in this subsection refer to the subclauses of TS 24.282 release 17.

Deferred Data Response Message:
Message definition: This message is sent by the MCData server (200) to the MCData UE as response to the list of deferred group communications request from the MCData UE.
Message type: DEFERRED DATA RESPONSE
Direction: Server to UE

The table 1 depicting the content of the deferred data response message. The number of ‘Deferred FD signalling payload’ element depends on the ‘Number of payloads’ information element value (i.e. as many entries as that of ‘Number of payloads’ element value).

TABLE 1

| | Information | | Pres- | For- | |
|---|---|---|---|---|---|
| IEI | Element | Type/Reference | ence | mat | Length |
| | Deferred data | Message type | M | V | 1 |
| | response message | 15.2.2 | | | |
| | identity | | | | |
| | Number of | Number of payloads | M | V | 1 |
| | payloads | 15.2.12 | | | |
| 7A | Security | MCData Protected | O | TLV-E | 32-x |
| | parameters | Payload message | | | |
| | and Payload | 3GPP TS 33.180 | | | |
| 78 | Payload | Payload15.2.13 | O | TLV-E | 3-x |
| 7B | MCData group ID | MCData group ID | O | TLV-E | 4-x |
| | | 15.2.14 | | | |
| 52 | Deferred FD | Deferred FD signalling | O | TLV-E | 3-x |
| | signalling payload | payload15.2.27 | | | |

Only the ‘payload’ IE and its value applicability were specified in early versions of the present document from release 13 to release 16. The continued support for Payload element and its value is for backwards compatibility.

Deferred FD signalling payload: The Deferred FD signaling payload information element contains the signaling data payload of the FD request of the MCData client (100a). The Deferred FD signaling payload information element is coded as shown in FIGS. 11A and 11B. The Deferred FD signaling payload information element is a type 6 information element.

Procedure for handling the deferred messages: Embodiments herein capture the changes required at the MCData client (100a) and the MCData server (200) for handling the deferred messages. Changes mentioned here applicable to the specification 24.282 of release 17. Embodiments herein can be applied for earlier versions also. Subclauses mentioned in this subsection refer to the subclauses of TS 24.282 release 17.

MCData Client Procedures:

10.2.1.2.2 Mandatory Download

The MCData Client:
1) If a FD SIGNALLING PAYLOAD message contains a new conversation ID, shall instantiate a new conversation with the message ID in the FD SIGNALLING PAYLOAD identifying the first message in the conversation thread;
2) If the FD SIGNALLING PAYLOAD message contains an existing conversation ID and:
a) If the FD SIGNALLING PAYLOAD message does not contain an InReplyTo message ID, shall use the message ID in the FD SIGNALLING PAYLOAD to identify a new message in the existing conversation thread; and
b) If the FD SIGNALLING PAYLOAD message contains an InReplyTo message ID, shall associate the message to an existing message in the conversation thread as identified by the InReplyTo message ID in the FD SIGNALLING PAYLOAD, and use the Message ID in the FD SIGNALLING PAYLOAD to identify the new message;
3) may store the Conversation ID, Message ID, InReplyTo message ID and Date and time in local storage;
4) if the FD SIGNALLING PAYLOAD message does not contain an Application ID IE and does not contain an Extended application ID IE:
a) Shall determine that the payload contained in the Payload IE in the FD SIGNALLING PAYLOAD message is for user consumption;
b) Shall notify the user or application that the file identified by file URL in the Payload data in the Payload IE will be downloaded automatically; and
c) If the FD SIGNALLING PAYLOAD message contains a Metadata IE, shall deliver the contents of the metadata IE to the user or application;
5) If the FD SIGNALLING PAYLOAD message contains an application ID IE:
a) Shall determine that the payload contained in the payload IE in the FD SIGNALLING PAYLOAD message is not for user consumption;
b) If the application ID value is unknown, shall discard the FD message and exit this subclause;
c) If the application ID value is known, shall notify the application that the file identified by file URL in the payload data in the payload IE will be downloaded automatically; and
If the FD request is addressed to a non-MCData application that is not running, the MCData client (100a) starts the local non-MCData application. Subsequent automatic download of the file is then started and the file is delivered to that application.
d) If the FD SIGNALLING PAYLOAD message contains a Metadata IE, shall deliver the contents of the Metadata IE to the application;
6) If the FD SIGNALLING PAYLOAD message contains an extended application ID IE:
a) Shall determine that the payload contained in the payload IE in the FD SIGNALLING PAYLOAD message is not for user consumption;
b) If the extended application ID value is unknown, shall discard the FD message and exit this clause;
c) If the extended application ID value is known, shall notify the application that the file identified by file URL in the Payload data in the Payload IE will be downloaded automatically; and
If the FD request is addressed to a non-MCData application that is not running, the MCData client (100a) starts the local non-MCData application. Subsequent automatic download of the file is then started and the file is delivered to that application.
d) If the FD SIGNALLING PAYLOAD message contains a Metadata IE, shall deliver the contents of the Metadata IE to the application;
7) Shall generate an FD NOTIFICATION indicating acceptance of the FD request as specified in subclause 12.2.1.1;
8) Shall attempt to download the file as identified by the file URL in the Payload IE in the FD SIGNALLING PAYLOAD message, as specified in subclause 10.2.3.1; and
9) If the received FD SIGNALLING PAYLOAD message contains an FD disposition request type IE requesting a file download completed update indication or not, then after the file has been successfully downloaded, shall generate an FD NOTIFICATION indicating file download completed, by following the procedures in subclause 12.2.1.1 with following clarifications:
a) If the received FD SIGNALLING PAYLOAD message is not requested for a file download completed update indication in an FD disposition request type IE, shall not include the target MCData user by skipping the step 3) of subclause 12.2.1.1.

Non-Mandatory Download

The MCData Client:
1) If the FD SIGNALLING PAYLOAD message does not contain an Application ID IE and does not contain an Extended application ID IE:
a) Shall determine that the payload contained in the payload IE in the FD SIGNALLING PAYLOAD message is for user consumption;
b) Shall notify the user about the incoming FD request; and
c) If the FD SIGNALLING PAYLOAD message contains a Metadata IE, shall deliver the contents of the metadata IE to the user;
2) If the FD SIGNALLING PAYLOAD message contains an application ID IE:
a) Shall determine that the payload contained in the Payload IE in the FD SIGNALLING PAYLOAD message is not for user consumption;
b) If the Application ID value is unknown, shall discard the FD message and exit this subclause;
c) If the Application ID value is known, shall notify the application of the incoming FD request; and
If FD request is addressed to a non-MCData application that is not running, the MCData client (100a) starts the local non-MCData application.
d) If the FD SIGNALLING PAYLOAD message contains a Metadata IE, shall deliver the contents of the Metadata IE to the application;
2A) If the FD SIGNALLING PAYLOAD message contains an Extended application ID IE:
a) Shall determine that the payload contained in the Payload IE in the FD SIGNALLING PAYLOAD message is not for user consumption;
b) If the Extended application ID value is unknown, shall discard the FD message and exit this clause;
c) If the Extended application ID value is known, shall notify the application of the incoming FD request; and
NOTE 2: If the FD request is addressed to a non-MCData application that is not running, the MCData client (100a) starts the local non-MCData application.
d) If the FD SIGNALLING PAYLOAD message contains a Metadata IE, shall deliver the contents of the Metadata IE to the application;
3) Shall start a timer TDU2 (FD non-mandatory download timer) with the timer value as specified in subclause F.2.3;
4) Shall wait for the user or application to request to download the file indicated by file URL in the Payload data in the Payload IE in the FD SIGNALLING PAYLOAD message;
5) If the user or application accepts or rejects or decides to defer the FD request, shall stop timer TDU2 (FD non-mandatory download timer);
6) If the user deferred the FD request while the timer TDU2 (FD non-mandatory download timer) was running, shall generate an FD NOTIFICATION indicating deferral of the FD request as specified in subclause 12.2.1.1;
Once the timer TDU2 (FD non-mandatory download timer) has expired the FD request can only be accepted or rejected with an appropriate action by the MCData client (100a).
Once the timer TDU2 (FD non-mandatory download timer) has expired, no action is taken by the MCData client (100a) if the FD request is deferred.
7) If the user or application rejects the FD request, shall generate an FD NOTIFICATION indicating rejection of the FD request as specified in subclause 12.2.1.1 and shall exit this subclause; and
8) If the user accepts the FD request:
a) Shall generate an FD NOTIFICATION indicating acceptance of the FD request as specified in subclause 12.2.1.1;
b) If the FD SIGNALLING PAYLOAD message contains a new Conversation ID, shall instantiate a new conversation with the Message ID in the FD SIGNALLING PAYLOAD identifying the first message in the conversation thread;
c) If the FD SIGNALLING PAYLOAD message contains an existing Conversation ID and:
i) If the FD SIGNALLING PAYLOAD message does not contain an InReplyTo message ID, shall use the Message ID in the FD SIGNALLING PAYLOAD to identify a new message in the existing conversation thread; and
ii) If the FD SIGNALLING PAYLOAD message contains an InReplyTo message ID, shall associate the message to an existing message in the conversation thread as identified by the InReplyTo message ID in the FD SIGNALLING PAYLOAD, and use the Message ID in the FD SIGNALLING PAYLOAD to identify the new message;
d) May store the Conversation ID, Message ID, InReplyTo message ID and Date and time in local storage;
e) Shall attempt to download the file as identified by the file URL in the Payload IE in the FD SIGNALLING PAYLOAD message, as specified in subclause 10.2.3.1; and
f) If the received FD SIGNALLING PAYLOAD message contains an FD disposition request type IE requesting a file download completed update or not, then after the file download has been successfully downloaded, shall generate an FD NOTIFICATION by following the procedures in subclause 12.2.1.1 with following clarifications:
i) If the received FD SIGNALLING PAYLOAD message is not requested for a file download completed update indication in an FD disposition request type IE, shall not include the target MCData user by skipping the step 3) of subclause 12.2.1.1.

Receiving a list of deferred group communications: Upon receipt of a “SIP MESSAGE response for the list of deferred group communications request”, the MCData client (100a):
1) Shall generate a SIP 200 (OK) response according to rules and procedures of 3GPP TS 24.229;
2) Shall send the SIP 200 (OK) response towards the MCData server (200) according to rules and procedures of 3GPP TS 24.229;
3) Shall decode the contents of the application/vnd.3gpp.mcdata-signalling MIME body:
a) If the application/vnd.3gpp.mcdata-signalling MIME body contains DEFERRED DATA RESPONSE message as specified in subclause 15.1.12:
i) for each deferred FD signalling payload, if payload type is set to “FILEURL”, shall store the required data or entire FD signalling payload and the Group ID information; and
4) Shall present to MCData user, the list of file URLs which were deferred with optionally other informations such as Originator, Group ID, Conversation ID, Message ID, InReplyTo message ID and Date and time etc.

MCData Server (Participating MCData Function) Procedures:

11.3.3.2 Sending a List of Deferred Group Communications

To send the list of deferred group communications, the participating MCData function:
1) Shall build the SIP MESSAGE request as specified in subclause 6.3.2.1;
2) Shall generate DEFERRED DATA RESPONSE message as specified in subclause 15.1.12.1;
3) Shall include in the SIP request, the DEFERRED DATA RESPONSE message in an application/vnd.3gpp.mcdata-signalling MIME body as specified in subclause E.1; and
4) Shall send the SIP MESSAGE request towards the participating MCData function according to rules and procedures of 3GPP TS 24.229.

When generating a DEFERRED DATA RESPONSE message as specified in subclause 15.1.12, the participating MCData function:
1) Shall set the number of payloads IE to the number of FD using HTTP communication which are deferred as per the stored file list:
a) For each deferred file from the list, shall copy the payload IE value from the stored list to the payload IE value of the outgoing message being generated; or
2) Shall set the number of payloads IE to the number of FD using HTTP communication which are deferred as per the stored deferred group communications:
a) For each deferred group communication, shall copy the deferred FD signalling payload IE value(s) from the stored list to the deferred FD signalling payload IE value(s) of the outgoing message being generated; and
b) Shall copy the MCData group ID(s) from the stored list to the MCData group ID IE value(s) of the outgoing message.
NOTE: Only the ‘payload’ IE and its value population from the stored list of ‘payload’ IE and its value as described in step 1) applicability were specified in early versions of the present document from release 13 to release 16. The continued support for Payload element and its value is for backwards compatibility.

Participating MCData function receives disposition notification from a MCData user, Upon receipt of a:
“SIP MESSAGE request for SDS disposition notification for MCData server (200)”; or
“SIP MESSAGE request for FD disposition notification for MCData server (200)”;
the participating MCData function:
1) If unable to process the request due to a lack of resources or a risk of congestion exists, may reject the SIP MESSAGE request with a SIP 500 (Server Internal Error) response. The participating MCData function may include a Retry-After header field to the SIP 500 (Server Internal Error) response as specified in IETF RFC 3261 and skip the rest of the steps;
2) Shall determine the MCData ID of the calling user from the public user identity in the P-Asserted-Identity header field of the SIP MESSAGE request;
NOTE: The MCData ID of the calling user is bound to the public user identity at the time of service authorization, as documented in subclause 7.3.
3) If the participating MCData function cannot find a binding between the public user identity and an MCData ID or if the validity period of an existing binding has expired, then the participating MCData function shall reject the SIP MESSAGE request with a SIP 404 (Not Found) response with the warning text set to “141 user unknown to the participating function” in a Warning header field as specified in subclause 4.9, and shall not continue with any of the remaining steps;
4) Void;
5) If the SIP MESSAGE is a “SIP MESSAGE request for SDS disposition notification for MCData server (200)” containing an SDS disposition notification type set to a value of “UNDELIVERED”, shall temporarily store the message for re-delivery, shall start timer TD1 (SDS re-delivery timer) with the timer value as specified in subclause F.2.1, and shall not continue with the remaining steps;
NOTE: The participating MCData function attempts re-delivery of the SDS message after timer TD1 (SDS re-delivery timer) expiry.
6) If the SIP MESSAGE is a “SIP MESSAGE request for SDS disposition notification for MCData server (200)” containing an SDS disposition notification type set to a value of “DELIVERED”, “READ” or “DELIVERED AND READ” and the message was temporarily stored for re-delivery, shall delete the message from temporary store and shall stop TD1 (SDS re-delivery timer);
6a) If the SIP MESSAGE is a “SIP MESSAGE request for FD disposition notification for MCData server (200)”, and the FD disposition notification type IE is set as “FILE DOWNLOAD COMPLETED” as specified in subclause 15.2.6 and target MCData user ID is not included as specified in the step 3) of subclause 12.2.1.1, shall skip the rest of the steps of this subclause after sending the response as follows:
a) Shall generate a SIP 200 (OK) response as specified in 3GPP TS 24.229;
b) Shall send the SIP 200 (OK) response to the MCData client (100a) according to 3GPP TS 24.229; and
c) Shall clear the corresponding stored deferred group communication; and
NOTE: The step 6a) is not applicable for the early versions of the present document of release 17 for backwards compatibility.
7) Shall generate a SIP MESSAGE request in accordance with 3GPP TS 24.229 and IETF RFC 3428;
8) Shall set the Request-URI of the outgoing SIP MESSAGE request to the public service identity of the controlling MCData function;
NOTE: How the participating MCData function determines the controlling MCData function to forward notification message is out of scope of the present document.
9) Shall copy all MIME bodies included in the incoming SIP MESSAGE request to the outgoing SIP MESSAGE request;
10) If not already included as part of step 8) above, shall include an application/vnd.3gpp.mcdata-info+xml MIME body in the outgoing SIP MESSAGE request, containing an <mcdata-calling-user-id> element set to the MCData ID of the originating user;
11) If the SIP MESSAGE is a “SIP MESSAGE request for SDS disposition notification for MCData server (200)”, shall include the ICSI value “urn:urn-7:3gpp-service.ims.icsi.mcdata.sds” (coded as specified in 3GPP TS 24.229), into the P-Asserted-Service header field of the outgoing SIP MESSAGE request;
12) If the SIP MESSAGE is a “SIP MESSAGE request for FD disposition notification for MCData server (200)”, shall include the ICSI value “urn:urn-7:3gpp-service.ims.icsi.mcdata.fd” (coded as specified in 3GPP TS 24.229), into the P-Asserted-Service header field of the outgoing SIP MESSAGE request;
13) If the SIP MESSAGE is a “SIP MESSAGE request for FD disposition notification for MCData server (200)”, and the FD disposition notification type IE is set as “FILE DOWNLOAD REQUEST ACCEPTED” or “FILE DOWNLOAD REQUEST REJECTED” as specified in subclause 15.2.6, shall remove the file from the stored file list;
14) Shall set the P-Asserted-Identity in the outgoing SIP MESSAGE request to the public user identity in the P-Asserted-Identity header field contained in the received SIP MESSAGE request; and
15) Shall send the SIP MESSAGE request as specified to 3GPP TS 24.229.

Upon receipt of a SIP 202 (Accepted) response in response to the above SIP MESSAGE request, the participating MCData function:
1) Shall generate a SIP 202 (Accepted) response as specified in 3GPP TS 24.229; and
2) Shall send the SIP 202 (Accepted) response to the MCData client (100a) according to 3GPP TS 24.229.

Upon receipt of a SIP 200 (OK) response in response to the above SIP MESSAGE request, the participating MCData function:
1) Shall generate a SIP 200 (OK) response as specified in 3GPP TS 24.229; and
2) Shall send the SIP 200 (OK) response to the MCData client (100a) according to 3GPP TS 24.229.

Upon receipt of a SIP 4xx, 5xx or 6xx response to the above SIP MESSAGE request, the participating MCData function:
1) Shall generate a SIP response according to 3GPP TS 24.229;
2) Shall include Warning header field(s) that were received in the incoming SIP response; and
3) Shall forward the SIP response to the MCData client (100a) according to 3GPP TS 24.229.

Procedure for handling the deferred messages: In this method, the MCData server (200) shall add an indication in each deferred communication while sending the list of deferred messages if the originator of communication has not requested for the file download complete updated disposition notification. The MCData client (100a) shall return the indication back to the MCData server (200) while sending the disposition notification. Based on this indication, the MCData server (200) can either forward the disposition to the originator who has requested for it or self-consume to update the deferred list or any other purpose.

Alternative solution for extending the payload present in the DEFERRED DATA RESPONSE: As per TS 24.282, the DEFERRED DATA RESPONSE carries the payload which contains only the File URL. Embodiments herein propose to extend the payload to carry XML or JSON data which carries all the relevant information related to the FD communication which was deferred by the MCData user earlier. The payload which is currently carrying file URL can be extended to carry the additional information that is present in the FD signalling payload.

Updating deferred messages object: The deferred messages objects being deposited into the MCData message store or the deferred messages list being maintained by the MCData server (200) has to be updated for the following reasons:
1. When the MCData user downloads the file, which was deferred by the MCData user earlier
2. When the TTL of the file which was deferred earlier by the MCData user is expired. In this case, the deferred message object has to be updated saying “Data expired and not available to download anymore”
3. Updating the deferred message object in MCData message store or deferred message list maintained by the MCData server (200) on receiving MCData download completed report from the MCData client (100a).

MCData server mandating the download completed report: Currently, the MCData server (200) requests for disposition indication for file download completed report only when the MCData client (100a) distributing the file requested for it. If the distributing MCData client (100a) is not requesting for the disposition indication for download completed report, then there is no way for the MCData server (200) to know whether the file is downloaded or not especially in the case where the file download is deferred and downloaded later since the file is downloaded by the recipient from the MCData content server (20). In order to handle this case, embodiments herein propose that the MCData server (200) mandatorily requests for the disposition indication for download completed report from the recipients irrespective of whether the MCData user distributing the file requests for it or not. But MCData server (200) should keep track of which MCData user requested for download completed report and send the disposition notification of download completed report to those MCData users who have requested for download completed report.

In the case, where the deferred message is handled as described in Section 8.1.1, on receiving the MCData download completed report and if there is an object in the deferred messages list corresponding to the transaction identifier in the received MCData download completed report, then the MCData server (200) updates that object residing in the MCData message store. It may also delete that object from the deferred messages list since the transaction is completed.

In the case where the deferred messages are handled by MCData server (200) which is an existing procedure as described in TS 24.282, on receiving the MCData download completed report, the MCData server (200) updates the corresponding deferred message and may also delete the message from the list since transaction is completed.

Table 2 depicts the MCData FD request using the HTTP/MCData server (200) to the MCData client (100a).

TABLE 2

| Information element | Status | Description |
|---|---|---|
| MCData ID | M | The identity of the MCData user |
| | | sending file |
| Functional alias | O | The associated functional alias of |
| | | the MCData user sending file |
| MCData ID | M | The identity of the MCData user |
| | | receiving file |
| Conversation identifier | M | Identifies the conversation |
| Transaction identifier | M | Identifies the transaction |
| Reply identifier | O | Identifies the original MCData |
| | | transaction to which the current |
| | | transaction is a reply to |
| Disposition indication | M | Indicates whether the downloaded |
| | (Note) | completed reported is expected or not |
| Download indication | O | Indicates mandatory download |
| Content reference | M | URL reference to the content and file |
| | | metadata information. |

(Note):
The MCData server (200) requires the download completed report even if the MCData user sending file not requested for it in order to manage the deferred messages.

MCData client (100a) sending the MCData download completed report mandatorily: Alternatively, embodiments herein propose that the receiving MCData client (100a) should send the MCData download completed report when the MCData client (100a) downloads the file which was deferred previously irrespective of whether the MCData user sending the file requested for it or not. The MCData client (100a) shall differentiate the MCData download completed report that is being sent without requested by the MCData user who distributed the file and the one being sent since it is requested by the MCData user who distributed the file. For the former case, the MCData client (100a) shall not include the MCData ID of the MCData user who distributed the file. This will indicate to the MCData server (200) that this download completed report is just to update the deferred messages. The MCData server (200) on receiving the MCData download completed report containing the MCData ID of the sending user shall check the deferred messages list and update it if it is for the file which was deferred earlier and also sends the MCData download completed to the MCData user who distributed the file. Table 3 depicts the MCData download completed report.

TABLE 3

| Information element | Status | Description |
|---|---|---|
| MCData ID | O | The identity of the MCData user |
| | (Note) | sending FD request |
| MCData ID | M | The identity of the MCData user |
| | | sending response |
| Conversation identifier | M | Identifies the conversation |
| Transaction identifier | M | Identifies the transaction |
| Reply identifier | M | Identifies the original MCData |
| | | transaction to which the current |
| | | transaction is a reply to |
| Disposition | M | Indication that the client has completed |
| confirmation | | downloading file |

(Note):
MCData client shall include the MCData ID of the sending user only if the disposition indication is requested by the MCData user sending the file.

Embodiments herein propose that the mandating of Download completed report from the receiving MCData client (100a) for the below reasons:
For Updating/Purging of the deferred message list which is being proposed herein.
For depositing the FD communication using HTTP as an object into the MCData message store account of the user. If there is no download completed indication is received at the MCData server (200) then there is no trigger for the MCData server (200) to deposit the FD communication using HTTP as an object.

Updating the deferred message object when the time to live (TTL) of the file shared is expired: The file distributed by the MCData user has expiry associated with it and it will not be available for the recipients to download incase if they have deferred the file download and the TTL is expired. Currently, the MCData server (200) is responsible for tracking the expiry and notifying the MCData clients (100a) when expired. Embodiments herein propose alternate ways of how the expiry of the file is handled if the deferred messages list is stored in the MCData message store. TTL is mandatorily to be shared by the MCData user sending the file.

MCData server handling the TTL: The MCData server (200) can handle the TTL of the file and on expiry it shall update the corresponding deferred message object stored in the MCData message store account of the user by providing the MCData update a stored object request. The MCData server (200) shall maintain the list of object identifiers corresponding to the deferred messages deposited into the MCData user's account of the MCData message store.

MCData Message store handling the TTL: Whenever a deferred message object is deposited into the MCData message store, the MCData Message store function shall track the expiry of the file shared. It can track either by starting a timer or how it tracks is outside the scope of the embodiments herein. Once the TTL of the file is expired the MCData message store function updates the deferred message object stating that “Data is expired and not available for download anymore”

MCData client handling the TTL: Since the MCData client (100a) has access to the deferred message object deposited in the user's account of the MCData message storage it can itself track the TTL of the file shared and notify the user that the “Data is expired and not available for download anymore” when the TTL of the file is expired and also update the corresponding object in the MCData message store account of the user by providing the MCData update a stored object request.

FIG. 4 shows various hardware components of the MCPPT client (100a), according to embodiments as disclosed herein. In an embodiment, the MCPTT client (100a) includes a MCData controller (110), a communicator (120), a memory (130), and a processor (140). The processor (140) is operated with the MCData controller (110), the communicator (120), and the memory (130). The MCData controller (110) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The MCData handler (110) is configured to obtain the list including the deferred data group communication message. Further, the MCData handler (110) is configured to send the MCData deferred messages list request to get the MCData deferred messages list to the MCData server (200) upon obtaining the list of deferred data group communication message. Based on the received MCData deferred messages list request, the MCData handler (110) is configured to receive the MCData deferred messages list response from the MCData server (200). The MCData deferred messages list response includes the MCData group ID, the deferred signalling payload and the one or more parameter.

Further, the MCData handler (110) is configured to send the disposition notification to the MCData server (200). The disposition notification is targeted to the FD request associated with another MCData client (100b) if the another MCData client (100b) is requested for the disposition notification.

Further, the processor (140) is configured to execute instructions stored in the memory (130) and to perform various processes. The communicator (120) is configured for communicating internally between internal hardware components and with external devices via one or more networks. The memory (130) also stores instructions to be executed by the processor (140). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the plurality of modules/controller may be implemented through an Artificial intelligence (AI) model. A function associated with AI may be performed through the non-volatile memory, the volatile memory, and the processor (140). The processor (140) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 4 shows various hardware components of the MCPPT client (100a) but it is to be understood that other embodiments are not limited thereon. In other embodiments, the MCPPT client (100a) may include less or more number of components. Further, the labels or names of the components are used only for illustrative purpose and does not limit the scope of the invention. One or more components can be combined together to perform same or substantially similar function in the MCPPT client (100a).

FIG. 5 shows various hardware components of the MCPPT server (200), according to embodiments as disclosed herein. In an embodiment, the MCPTT server (200) includes a MCData controller (210), a communicator (220), a memory (230), and a processor (240). The processor (240) is operated with the MCData controller (210), the communicator (220), and the memory (230). The MCData controller (210) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

In an embodiment, the MCData handler (210) is configured to receive the MCData deferred messages list request to get the MCData deferred messages list from the MCData client (100a). Based on the received MCData deferred messages list request, the MCData handler (210) is configured to send the MCData deferred messages list response to the MCData client (100a). The MCData deferred messages list response includes the MCData group ID, the deferred signalling payload and the one or more parameter.

Further, the MCData handler (210) is configured to receive the disposition notification. The disposition notification is targeted to the FD request associated with another MCData client (100b) if the another MCData client (100b) is requested for the disposition notification.

In another embodiment, the MCData handler (210) is configured to receive the FD disposition notification message from the first MCData client (100a). After receiving the FD disposition notification message, the MCData handler (210) is configured to determine whether the disposition information has been indicated in the FD disposition notification message. The disposition information has been requested by the second MCData client (100b). If the disposition information has been indicated in the FD disposition notification message, the MCData handler (210) is configured to share the FD disposition notification message with the second MCData client (100b), clear the deferred message in the deferred message list in the MCData server (200), and update the deferred message list in the MCData server (200). If the disposition information not indicated in the FD disposition notification message, the MCData handler (210) is configured to clear the deferred message in the deferred message list in the MCData server (200) and update the deferred message list in the MCData server (200).

Further, the MCData handler (210) is configured to receive the FD disposition notification response message from the second MCData client (100b) and forward the FD disposition notification response message to the first MCData client (100a).

Further, the processor (240) is configured to execute instructions stored in the memory (230) and to perform various processes. The communicator (220) is configured for communicating internally between internal hardware components and with external devices via one or more networks. The memory (230) also stores instructions to be executed by the processor (240). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Further, at least one of the plurality of modules/controller may be implemented through the AI model. A function associated with AI may be performed through the non-volatile memory, the volatile memory, and the processor (240). The processor (240) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 5 shows various hardware components of the MCPPT server (200) but it is to be understood that other embodiments are not limited thereon. In other embodiments, the MCPPT server (200) may include less or more number of components. Further, the labels or names of the components are used only for illustrative purpose and does not limit the scope of the invention. One or more components can be combined together to perform same or substantially similar function in the MCPPT server (200).

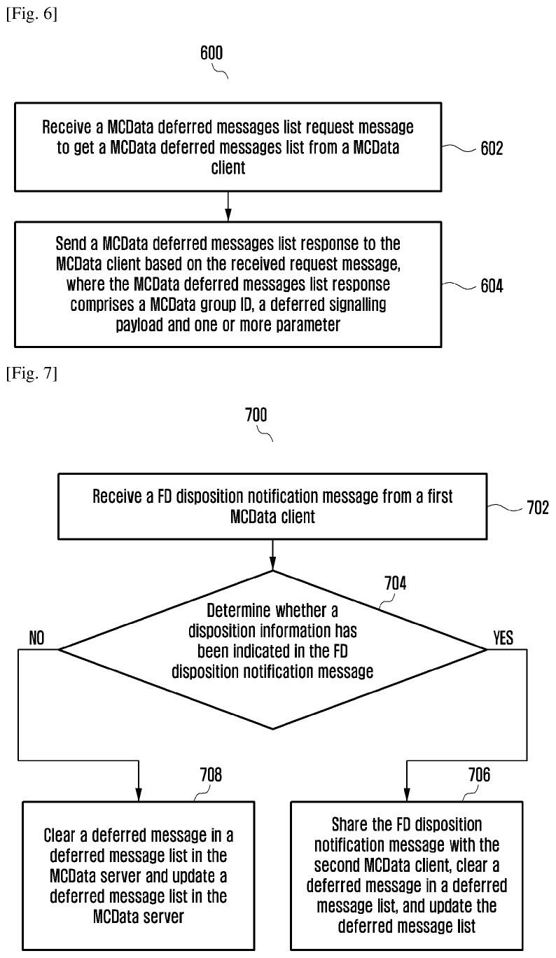

FIG. 6 and FIG. 7 are flow charts (600 and 700) illustrating a method, implemented by the MCPTT server (200), for handling the MCS in the wireless communication network (300), according to embodiments as disclosed herein.

The operations (602 and 604) are performed by the MCData controller (210). As shown in the FIG. 6, the method includes receiving the MCData deferred messages list request to get the MCData deferred messages list from the MCData client (100a). Further, the method includes sending the MCData deferred messages list response to the MCData client (100a) based on the received MCData deferred messages list request. The MCData deferred messages list response includes the MCData group ID, the deferred signalling payload and the one or more parameter.

The operations (702-708) are performed by the MCData controller (210). As shown in the FIG. 7, at 702, method includes receiving the FD disposition notification message from the first MCData client (100a). At 704, the method includes determining whether the disposition information has been indicated in the FD disposition notification message. The disposition information has been requested by the second MCData client (100b). If the disposition information has been indicated in the FD disposition notification message then, at 706, the method includes sharing the FD disposition notification message with the second MCData client (100b), clearing the deferred message in the deferred message list in the MCData server (200), and updating the deferred message list in the MCData server (200). If the disposition information not indicated in the FD disposition notification message then, at 708, the method includes clearing the deferred message in the deferred message list in the MCData server (200) and updating the deferred message list in the MCData server (200).

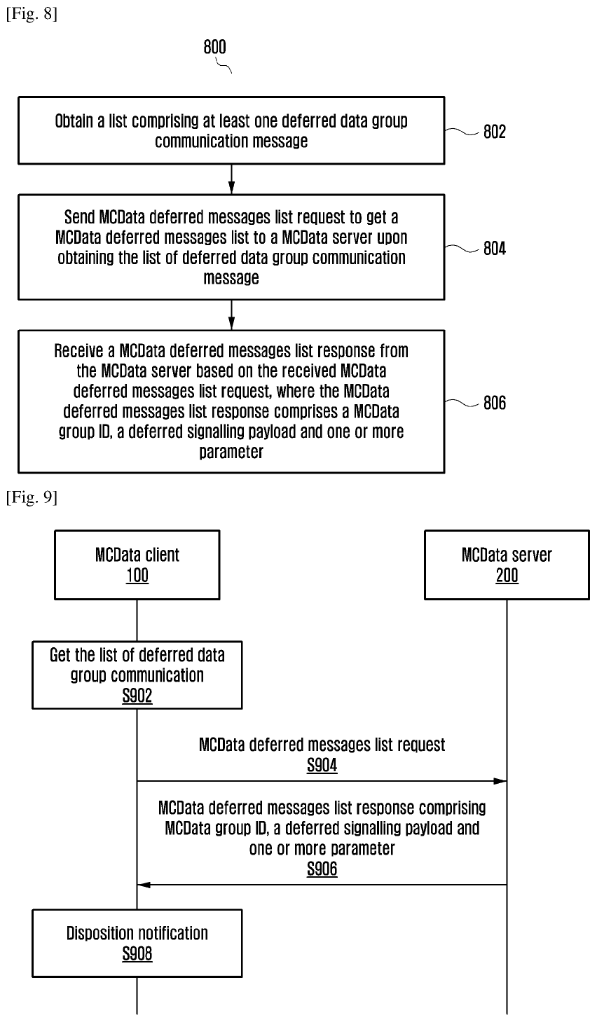

FIG. 8 is a flow chart (800) illustrating a method, implemented by the MCPTT client (100a), for handling the MCS in the wireless communication network (300), according to embodiments as disclosed herein. The operations (802-806) are performed by the MCData controller (110).

At 802, the method includes obtaining the list comprising at least one deferred data group communication message. At 804, the method includes sending the MCData deferred messages list request to get the MCData deferred messages list to the MCData server (200) upon obtaining the list comprising of at least one deferred data group communication message. At 806, the method includes receiving the MCData deferred messages list response from the MCData server (200) based on the MCData deferred messages list request. The MCData deferred messages list response comprises the MCData group ID, the deferred signalling payload and the one or more parameter.

The various actions, acts, blocks, steps, or the like in the flow charts (600-800) may be performed in the order presented, in a different order or simultaneously. Further, in some embodiments, some of the actions, acts, blocks, steps, or the like may be omitted, added, modified, skipped, or the like without departing from the scope of the invention.

FIG. 9 is a sequence flow diagram illustrating step by step operations for handling the MCS in the wireless communication network (300), while accessing list of deferred data group communications, according to embodiments as disclosed herein. At S902, the MCData client (100a) gets the list of deferred data group communication. At S904, the MCData client (100a) sends the MCData deferred messages list request to the MCData server (200). At S906, the MCData server (200) sends the MCData deferred messages list response including the MCData group ID, the deferred signalling payload and the at least one parameter. At S908, the MCData client (100a) sends the disposition notification to the MCData server (200).

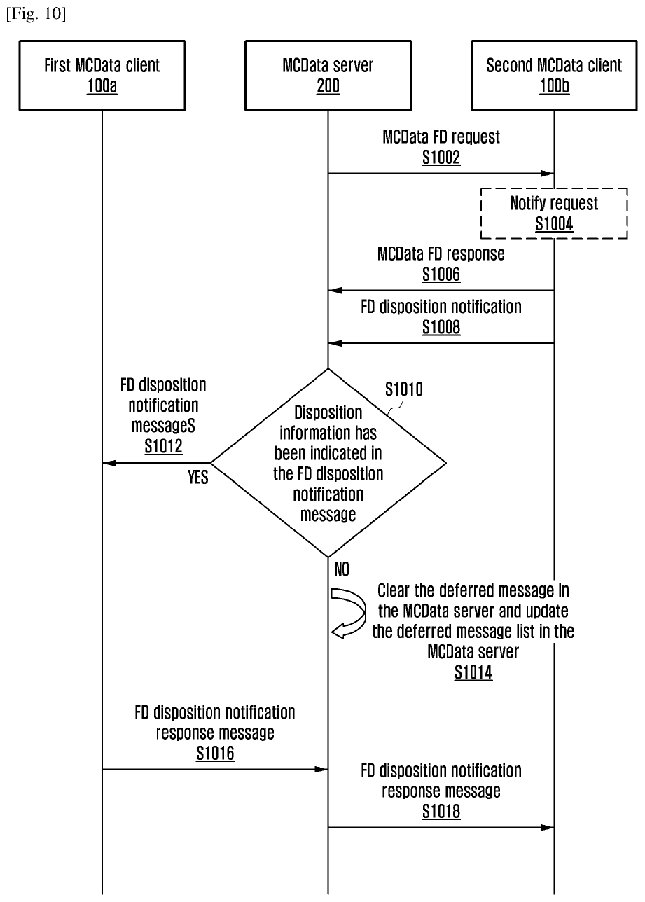

FIG. 10 is a sequence flow diagram illustrating step by step operations for handling the MCS in the wireless communication network (300), while handling the disposition notification, according to embodiments as disclosed herein. At S1002, the MCData server (200) sends the MCData FD request to the second MCData client (100b). At 51004, the second MCData client (100b) notifies the request. At S1006, the second MCData client (100b) sends the MCData FD response to the MCData server (200). At S1008, the disposition notification is requested in the received MCData FD request by the first MCData client (100a) and the second MCData client (100b) sends the FD disposition notification to the MCData server (200) with the target of the disposition notification information.

At S1010, the MCData server (200) determines whether the target of the disposition information has been indicated in the FD disposition notification message. If the disposition information has been indicated in the FD disposition notification message then, at S1012, the MCData server (200) sends the FD disposition notification message to the first MCData client (100a). Further, the MCData server (200) clears the deferred message in the deferred message list and update the deferred message list.

If the target of the disposition information has not been indicated in the FD disposition notification message then, at S1014, the MCData server (200) clears the deferred message in the deferred message list and updates the deferred message list. At 51016, the first MCData client (100a) sends the FD disposition notification response message to the MCData server (200). At S1018, the MCData server (200) forwards the FD disposition notification response message to the second MCData client (100b).

FIG. 11 depicts a deferred signalling payload information element (1100), according to embodiments as disclosed herein.

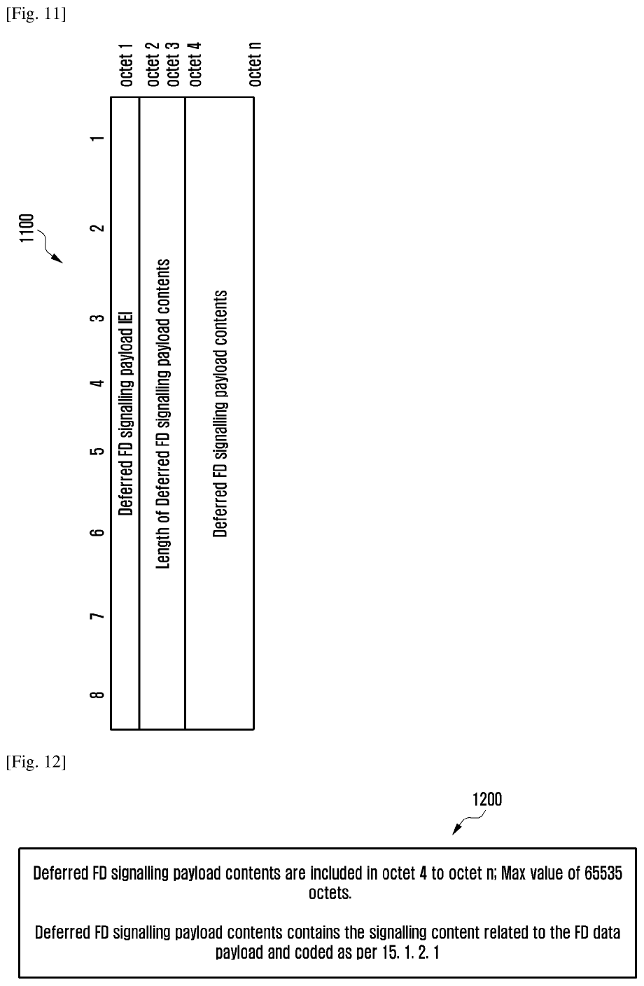

FIG. 12 depicts deferred FD signalling payload contents (1200) respectively, according to embodiments as disclosed herein.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the scope of the embodiments as described herein.

1. A method for handling a mission critical (MC) service in a wireless communication system (300), the method comprising:
receiving, by a Mission Critical Data (MCData) server (200), a MCData deferred messages list request to get a MCData deferred messages list from a MCData client (100a); and
sending, by the MCData server (200), a MCData deferred messages list response to the MCData client (100a) based on the received MCData deferred messages list request, wherein the MCData deferred messages list response comprises a MCData group identifier (ID), a deferred signalling payload and at least one parameter.

2. The method as claimed in claim 1, wherein the MCData server (200) receives the MCData deferred messages list request to get the MCData deferred messages list from the MCData client (100a) when the MCData client (100a) wants to obtain a list of deferred data group communications.

3. The method as claimed in claim 1, wherein the method further comprises:
receiving, by the MCData server (200), a disposition notification, wherein the disposition notification is targeted to a File Distribution (FD) request associated with another MCData client (100b) if the another MCData client (100b) is requested for the disposition notification.

4. The method as claimed in claim 1, wherein the deferred signalling payload comprises a signalling content related to a FD data payload and coded as per 3GPP 24.282 standard, wherein an information element (IE) of the deferred FD signaling payload is a type 6 information element, and wherein the at least one parameter associated with the MCData deferred messages list request that is deferred comprises an originator of a MCData communication request, a conversation identifier (ID), a message ID, an in-reply-to message ID, an application ID, a FD disposition request type, a payload, a metadata, an extended application ID and a date and time.

5. A method for handling a mission critical (MC) service in a wireless communication system (300), the method comprising:
receiving, by a Mission Critical Data (MCData) server (200), a File Distribution (FD) disposition notification message from a first MCData client (100a);
determining, by the MCData server (200), whether a disposition information has been indicated in the FD disposition notification message, wherein the disposition information has been requested by a second MCData client (100b); and
performing, by the MCData server (200), one of
sharing the FD disposition notification message with the second MCData client (100b), clearing a deferred message in a deferred message list in the MCData server (200), and updating the deferred message list in the MCData server (200), upon determining that the disposition information has been indicated in the FD disposition notification message, and
clearing a deferred message in a deferred message list in the MCData server (200) and updating the deferred message list in the MCData server (200), upon determining that the disposition information not indicated in the FD disposition notification message.

6. The method as claimed in claim 6, wherein the disposition notification message allows the MCData server (200) to identify whether the first MCData client (100a) has downloaded a content or not.

7. The method as claimed in claim 6, wherein the method further comprises:
receiving, by the MCData server (200), a FD disposition notification response message from the second MCData client (100b); and
forwarding, by the MCData server (200), the FD disposition notification response message to the first MCData client (100a).

8. A method for handling a mission critical (MC) service in a wireless communication system (300), the method comprising:
obtaining, by a Mission Critical Data (MCData) client (100a), a list comprising at least one deferred data group communication message;
sending, by the MCData client (100a), a MCData deferred messages list request to get a MCData deferred messages list to a MCData server (200) upon obtaining the list comprising of at least one deferred data group communication message; and
receiving, by the MCData client (100a), a MCData deferred messages list response from the MCData server (200) based on the MCData deferred messages list request, wherein the MCData deferred messages list response comprises a MCData group identifier (ID), a deferred signalling payload and at least one parameter.

9. The method as claimed in claim 8, wherein receiving, by the MCData client (100a), the MCData deferred messages list response comprises:
performing at least one of:
setting a number of payloads information element (IE) to a number of File Distribution (FD) FD using a communication which is deferred as per a stored deferred group communication;
copying a deferred FD signalling payload IE value from a stored list to a deferred FD signalling payload IE value of an outgoing message being generated for each deferred group communication; and
copying a MCData group ID from a stored list to a MCData group ID IE values of an outgoing message.

10. The method as claimed in claim 8, wherein the deferred signalling payload comprises a signalling content related to a File Distribution (FD) data payload and coded as per 3GPP 24.282 standard, wherein an information element (IE) of the deferred FD signaling payload is a type 6 information element, and wherein the at least one parameter associated with the MCData deferred messages list request that is deferred comprises an originator of a MCData communication request, a conversation identifier (ID), a message ID, an in-reply-to message ID, an application ID, a FD disposition request type, a payload, a metadata, an extended application ID and a date and time.

11. The method as claimed in claim 8, wherein the method further comprises:
sending, by the MCData client (100a), a disposition notification to the MCData server (200), wherein the disposition notification is targeted to another MCData client (100b) of a File Distribution (FD) request if the another MCData client (100b) is requested for the disposition notification.

12-14. (canceled)
